(19) United States
(12) Patent Application Publication
(10) Pub. No.: US 2024/0394322 A1
(43) Pub. Date: Nov. 28, 2024

(54) TERMINAL DEVICE, INFORMATION PROCESSING METHOD, AND RECORDING MEDIUM

(71) Applicant: PLAID, INC., Tokyo (JP)

(72) Inventors: Naoki SHIBAYAMA, Tokyo (JP); Yuki MAKINO, Tokyo (JP); Tomoki KOGA, Tokyo (JP); Kei TAMIYA, Tokyo (JP)

(21) Appl. No.: 18/554,864

(22) PCT Filed: Feb. 2, 2022
(86) PCT No.: PCT/JP2022/003967

§ 371 Date: Apr. 24, 2024

(30) Foreign Application Priority Data
Apr. 12, 2021 (JP) 2021-066947

(51) Int. Cl. G06F 16/958; G06F 16/957

(52) U.S. Cl. CPC G06F 16/958; G06F 16/957

(57) ABSTRACT

With conventional technologies, it is impossible to accumulate and use management information, which is information based on user operations on web pages, in a terminal device, in association with the web pages. With a terminal device 1 including: an operation acceptance unit 121 that accepts one or more operations performed on a web page; a management information acquisition unit 133 that acquires management information that is a set of pieces of operation information regarding the one or more operations, or a dynamic attribute value that is based on the set of pieces of operation information; and a management information accumulation unit 134 that accumulates the management information in association with a page identifier that identifies the web page, it is possible to accumulate and use management information that is based on user operations on web pages, in a terminal device, in association with the web pages.

### TECHNICAL FIELD

The present invention relates to a terminal device or the like that accumulates and use information that is based on operations performed on web pages.

### BACKGROUND ART

As a conventional technology, there is a bookmark that allows users to register the URLs of web pages. In addition, there is a conventional technology that allows users to save an image on a web page as a bookmark image together with address information corresponding thereto by performing a drag-and-drop operation, and display a desired web page by selecting the bookmark image. (See Patent Document 1).

### CITATION LIST

### Patent Document

Patent Document 1: JP 4247909B2

### SUMMARY OF INVENTION

### Technical Problem

However, with the conventional technologies, users cannot accumulate and use management information, which is information based on user operations on web pages, in a terminal device, in association with the web pages.

### Solution to Problem

A terminal device according to a first aspect of the present invention is a terminal device including: an operation acceptance unit that accepts one or more operations performed on a web page; a management information acquisition unit that acquires management information that is a set of pieces of operation information regarding the one or more operations, or a dynamic attribute value that is based on the set of pieces of operation information; and a management information accumulation unit that accumulates the management information in association with a page identifier that identifies the web page.

With such a configuration, it is possible to accumulate and use management information that is based on user operations performed on web pages, in association with the web pages.

A terminal device according to a second aspect of the present invention is the terminal device according to the first aspect of the invention, further including: a judgment unit that judges whether or not the management information acquired by the management information acquisition unit meets an action condition that is based on the set of pieces of operation information or the dynamic attribute value; and an action unit that, when the judgment unit judges that the management information meets the action condition, performs an action corresponding to the action condition.

With such a configuration, it is possible to perform an action corresponding to management information.

A terminal device according to a third aspect of the present invention is the terminal device according to the second aspect of the invention, wherein the action unit performs screen change processing to change the web page that is being output, or to output another screen on the web page.

With such a configuration, it is possible to perform an action such as changing the web page corresponding to the management information.

A terminal device according to a fourth aspect of the present invention is the terminal device according to the second aspect of the invention, wherein the action unit performs communication processing to start communication with another terminal device.

With such a configuration, it is possible to perform a chat corresponding to management information.

A terminal device according to a fifth aspect of the present invention is the terminal device according to any one of the second to fourth aspects of the invention, further including: a condition reception unit that receives the action condition; and a condition accumulation unit that accumulates the action condition.

With such a configuration, it is possible to receive an action condition used to judge whether or not to perform an action, from an external device.

A terminal device according to a sixth aspect of the present invention is the terminal device according to the fifth aspect of the invention, further including: a page access unit that accesses a web server to acquire a web page; and a page output unit that outputs the web page in response to the access, wherein the condition reception unit receives the action condition from the web server in response to the access.

With such a configuration, it is possible to receive an action condition from a web server in response to an access to a web page.

A terminal device according to a seventh aspect of the present invention is the terminal device according to any one of the second to sixth aspects of the invention, wherein the action condition is a condition that is based on a change in the dynamic attribute value.

With such a configuration, it is possible to perform an action based on an accepted operation, without using already accumulated management information.

A terminal device according to an eighth aspect of the present invention is the terminal device according to any one of the first to seventh aspects of the invention, wherein the management information accumulation unit accumulates only management information that meets a predetermined accumulation condition.

With such a configuration, it is possible to accumulate only necessary management information.

A terminal device according to a ninth aspect of the present invention is the terminal device according to the eighth aspect of the invention, wherein the accumulation condition is that the management information is used in the action condition.

With such a configuration, it is possible to accumulate only management information that is used to perform judgement using an action condition.

A terminal device according to a tenth aspect of the present invention is the terminal device according to any one of the first to ninth aspects of the invention, further including a management information transmission unit that transmits the management information to a server device.

With such a configuration, it is possible to transmit management information to a server device.

A terminal device according to an eleventh aspect of the present invention is the terminal device according to the tenth aspect of the invention, wherein the management information transmission unit transmits the management information to the server device only when a predetermined transmission condition is satisfied.

With such a configuration, it is possible to transmit management information to the server device only when necessary.

A terminal device according to a twelfth aspect of the present invention is the terminal device according to any one of the first to eleventh aspects of the invention, wherein the management information accumulation unit accumulates the management information in association with a browser that outputs the web page.

With such a configuration, it is possible to manage management information in association with a browser.

A server device according to a thirteenth aspect of the present invention is a server device including: a server storage unit that stores an action condition; and a server transmission unit that transmits the action condition to a terminal device.

With such a configuration, it is possible to transmit an action condition to a terminal device.

A server device according to a fourteenth aspect of the present invention is the server device according to the thirteenth aspect of the invention, further including a server management reception unit that receives management information from a terminal device, wherein the server transmission unit transmits an action condition to the terminal device when the management information satisfies a predetermined server transmission condition.

With such a configuration, it is possible to transmit an action condition to a terminal device when appropriate.

A server device according to a fifteenth aspect of the present invention is the server device according to the fourteenth aspect of the invention, further including: a server inspection unit that judges whether or not the management information received by the server management reception unit is valid; and a server output unit that outputs a result of the judgment by the server inspection unit.

With such a configuration, it is possible to inspect whether or not the management information in a terminal device is valid.

### Advantageous Effects of Invention

A terminal device according to the present invention makes it possible to accumulate and use management information that is based on user operations performed on web pages, in association with the web pages.

### BRIEF DESCRIPTION OF DRAWINGS

FIG. 1 is a conceptual diagram for an information system A according to a first embodiment.

FIG. 2 is a block diagram for the information system A according to the same.

FIG. 3 is a block diagram for a terminal device 1 according to the same.

FIG. 4 is a block diagram for a server device 2 according to the same.

FIG. 5 is a flowchart illustrating an operation example of the terminal device 1 according to the same.

FIG. 6 is a flowchart illustrating an example of management information processing according to the same.

FIG. 7 is a flowchart illustrating an example of management information processing according to the same.

FIG. 8 is a flowchart illustrating an operation example of the server device 2 according to the same.

FIG. 9 is a flowchart illustrating an operation example of a management terminal 3 according to the same.

FIG. 10 is a diagram showing a management information management table according to the same.

FIG. 11 is a diagram showing a dynamic processing information management table according to the same.

FIG. 12 is a diagram showing a user information management table according to the same.

FIG. 13 is a diagram showing a server dynamic processing information management table according to the same.

FIG. 14 is a conceptual diagram for an information system B according to the same.

FIG. 15 is a block diagram for the information system B according to the same.

FIG. 16 is an overview diagram for a computer system according to the same.

FIG. 17 is a block diagram for the computer system according to the same.

### DESCRIPTION OF EMBODIMENTS

Hereinafter, embodiments of a terminal device and so on will be described with reference to the drawings. Note that the constituent elements with the same reference numerals perform the same operations in the embodiment, and therefore redundant descriptions thereof may be omitted.

### First Embodiment

The present embodiment describes a terminal device that accumulates one or more pieces of management information in association with page identifiers (for example, URLs). Note that management information is accumulated in association with a browser, for example. Note that management information is a set of one or more pieces of operation information that are based on operations performed on web pages, or a dynamic attribute value that is based on the set of one or more pieces of operation information. Management information may be operation information corresponding to one operation performed on a web page.

In addition, the present embodiment describes a terminal device that performs an action corresponding to a condition when management information meets the condition. Note that examples of actions include screen switching, starting a chat, and so on. Examples of action conditions include a condition that is based on a change in the user's dynamic attribute values (for example, when the number of visits increases by one, when the rank increases by one, and so on).

In addition, the present embodiment describes a terminal device that receives an action condition from a web server. For example, an action condition is transmitted from a web server in response to an access to a web page.

In addition, the present embodiment describes a terminal device that accumulates only management information that meets a predetermined condition. Note that the predetermined condition is, for example, operation information or a dynamic attribute value included in an action condition. The operation information or the dynamic attribute value included in an action condition is an operation information or a dynamic attribute value used to make a judgment using the action condition.

In addition, the present embodiment describes a terminal device that transmits operation information or a dynamic attribute value to a server device. Note that the terminal device transmits operation information or a dynamic attribute value to the server device only when a predetermined condition is satisfied, for example.

In addition, the present embodiment describes a server device that transmits an action condition to a terminal device.

In addition, the present embodiment describes a server device that receives management information from a terminal device, and transmits an action condition to the terminal device when the management information satisfies a predetermined condition.

Furthermore, the present embodiment describes a server device that receives management information from a terminal device, and judges whether or not the management information is valid.

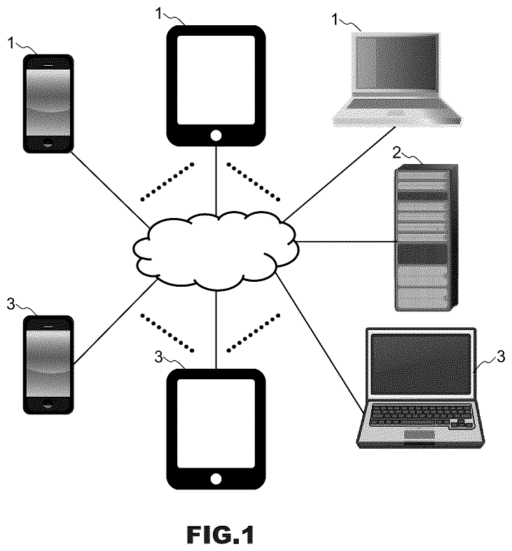

FIG. 1 is a conceptual diagram for an information system A according to the present embodiment. The information system A includes one or more terminal devices 1, one or more server devices 2, and one or more management terminals 3.

Each terminal device 1 is a terminal used by a user who performs operations on web pages. For example, each terminal device 1 is a terminal used by a user who browses web pages. For example, each terminal device 1 is a terminal used by a user who purchases products from an EC site. Each terminal device 1 is, for example, a so-called personal computer, a tablet terminal, a smartphone, or the like, and there is no limitation on the type thereof. Note that examples of operations on web pages include operations for browsing web pages, and operations for purchasing products from an EC site. It is preferable that the web pages or websites mentioned here are web pages or websites where user registration is performed and user information is managed.

Each server device 2 is a device that provides services to the terminal devices 1. Each server device 2 is a device that provides action conditions, which will be described later, to the terminal devices 1. Each server device 2 is, for example, a device that manages and provides web pages. That is to say, each server device 2 is, for example, a web server. However, each server device 2 is a device that performs only some of the functions of the server devices 2 described below, including the function of managing and providing action conditions to the user. Each server device 2 is, for example, an ASP server, a cloud server, or the like, and there is no limitation on the type thereof.

Each management terminal 3 is a terminal used by an administrator. The administrator is, for example, an administrator of a server device 2, and need only be a person who is not a user of a terminal device 1. Each management terminal 3 is, for example, a terminal used by an administrator who chats or holds a video conference with a user using a terminal device 1. Each management terminal 3 is, for example, a so-called personal computer, a tablet terminal, a smartphone, or the like, and there is no limitation on the type thereof.

It is preferable that the terminal devices 1, the server devices 2, and the management terminals 3 can communicate with each other via a network such as the Internet. Each management terminal 3 may be associated with one server device 2. In such a case, the administrator is the administrator of the one server device 2. Each management terminal 3 may also be associated with two or more server devices 2. In such a case, the administrator is the administrator of the two or more server devices 2.

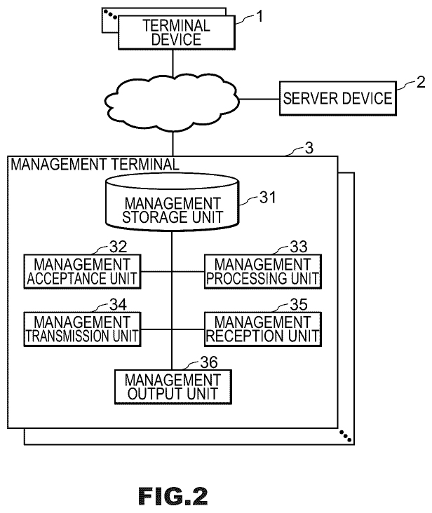

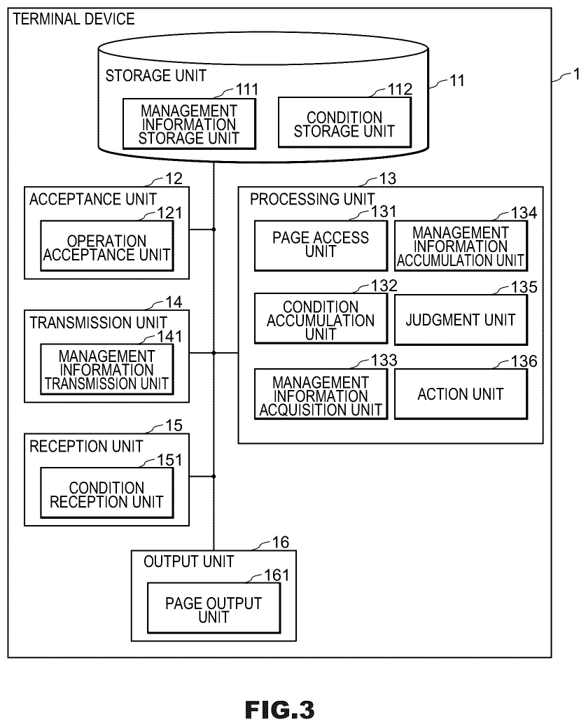

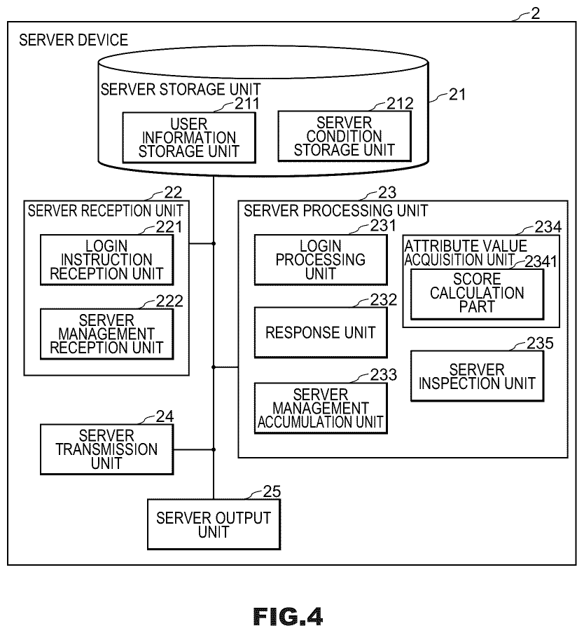

FIG. 2 is a block diagram for the information system A according to the present embodiment. FIG. 3 is a block diagram for a terminal device 1. FIG. 4 is a block diagram for a sever device 2.

The terminal device 1 includes a storage unit 11, an acceptance unit 12, a processing unit 13, a transmission unit 14, a reception unit 15, and an output unit 16. The storage unit 11 includes a management information storage unit 111 and a condition storage unit 112. The acceptance unit 12 includes an operation acceptance unit 121. The processing unit 13 includes a page access unit 131, a condition accumulation unit 132, a management information acquisition unit 133, a management information accumulation unit 134, a judgment unit 135, and an action unit 136. The transmission unit 14 includes a management information transmission unit 141. The reception unit 15 includes a condition reception unit 151. The output unit 16 includes a page output unit 161.

The server device 2 includes a severer storage unit 21, a server reception unit 22, a server processing unit 23, a server transmission unit 24, and a server output unit 25. The server storage unit 21 includes a user information storage unit 211 and a server condition storage unit 212. The server reception unit 22 includes a login instruction reception unit 221 and a server management reception unit 222. The server processing unit 23 includes a login processing unit 231, a response unit 232, a server management accumulation unit 233, an attribute value acquisition unit 234, and a server inspection unit 235. The attribute value acquisition unit 234 includes a score calculation part 2341.

The management terminal 3 includes a management storage unit 31, a management acceptance unit 32, a management processing unit 33, a management transmission unit 34, a management reception unit 35, and a management output unit 36.

The storage unit 11 included in the terminal device 1 stores various kinds of information. Examples of the various kinds of information include management information, which will be described later, an action condition, which will be described later, a user identifier, a user terminal identifier, user attribute values, an accumulation condition, which will be described later, a transmission condition, which will be described later, and arithmetic expression information used to calculate scores, which will be described later, and so on.

The user identifier is information identifying a user, and is an ID, for example. The user identifier may be a telephone number, a credit card number, an email address, or the like. The user terminal identifier is information identifying the terminal device 1, and is, for example, a cookie ID, a session identifier, an IP address, a MAC address, or the like.

Examples of the user attribute values include static attribute values. Each static attribute value is usually an invariable attribute value, but may also be regarded as an attribute value that does not change from moment to moment. Examples of the static attribute values include a name, an age, a sex, an address, a telephone number, a credit card number, an email address, a user terminal identifier, a user identifier, a password, and so on. The user terminal identifier is information identifying the terminal device 1, and is, for example, a cookie ID, a session identifier, an IP address, a MAC address, or the like. The user identifier is information identifying a user, and is an ID, for example. The user identifier may be a telephone number, a credit card number, an email address, or the like.

The management information storage unit 111 stores one or more pieces of management information. Note that management information is a set of pieces of operation information regarding one or more operations, or a dynamic attribute value that is based on the set of pieces of operation information. Note that the operations are operations performed on web pages. The operations may be operations performed on websites. The operations performed on websites may be regarded as operations performed on web pages. Operation information is information regarding operations performed by the user on web pages. Examples of web pages and websites include an EC site and a web page of an EC site. However, there is no limitation on the type of the websites.

The one or more pieces of management information are associated with a page identifier, for example. The page identifier is the identifier of a web page. The page identifier may be the identifier of a website. The page identifier is, for example, an URL, a URI, a website name, or the ID of a website.

Examples of operation information include information indicating that a button has been pressed, information indicating that an anchor has been specified, information regarding an operation performed to jump to another page, information input in a field, and so on. Examples of operation information include “rightButtonON” (indicating that the right mouse button has been pressed), “drug object A” (indicating that the object A has been dragged), “<purchased product ID>123<quantity>3” (indicating that three products identified by 123 have been purchased), “jump http://www.xxx.co.jp” (indicating that the web page identified by the URL “http://www.xxx.co.jp” has been accessed), and so on. The operation information mentioned here is typically primitive operation information, but it is preferable that the operation information is information that allows a user or administrator to see and judge the meaning and significance of the operation. That is to say, there is no limitation on the data structure of the operation information, the granularity of the information, or the like. Operation information is typically information specifying an operation performed by the user, but may also include information regarding processing performed by the server device 2 resulting from the user's operation.

Dynamic attribute values are attribute values that may dynamically change in response to the user's operation performed on a web page. Examples of dynamic attribute values include real-time dynamic attribute values and history information-using dynamic attribute values. Real-time dynamic attribute values are attribute values that change from moment to moment in real time. Examples of real-time dynamic attribute values include the stay time of the user on the web page that the user is currently viewing, the number of web pages viewed during the current stay, and so on. History information-using dynamic attribute values are dynamic attribute values that are acquired by also using the history of operation information regarding the visits in the past. Examples of history information-using dynamic attribute values include the number of purchases, the purchase amount, the total purchase amount, the average stay time, the average number of PVs, the number of visits, the score, which will be described later, and so on.

The condition storage unit 112 stores one or more action conditions. Each of the one or more action conditions is associated with a processing identifier, for example. Note that action conditions that are not associated with a specific processing identifier may be considered to be associated with a default processing identifier. The condition storage unit 112 may store one or more pieces of dynamic processing information each containing an action condition and a processing identifier.

Action conditions are conditions related to one or more attribute values of the user. Each action condition is a condition that uses one or more dynamic attribute values. Furthermore, it is preferable that each action condition is a condition that uses one or more real-time dynamic attribute values or one or more historical information usage dynamic attribute values. Each action condition may be a condition related to one or more static attribute values. Examples of action conditions include “<number of purchases>5 times or more”, “<score>70 or higher”, “<age> twenties, <number of purchases>5 times or more, 15<score>70 or higher”, and so on.

Each processing identifier is information identifying processing to be executed when a condition is satisfied. Processing may also be referred to as an action. Examples of processing identifiers include an ID, a function name, a method name, an address of a program corresponding to the processing, and so on. Each processing identifier may be an executable program. Each processing identifier may be any information as long as it is information used to execute processing corresponding to the condition.

The acceptance unit 12 accepts an instruction, information, and so on input from the user. Examples of instructions, information, and so on include an operation, operation information, a login instruction, a page identifier, a user registration instruction, and so on.

The login instruction is an instruction to log in. A login instruction contains, for example, a user identifier. A login instruction contains, for example, a user identifier and a password.

A user registration instruction is an instruction used to register the user to a server device 2. A user registration instruction contains, for example, one or more static attribute values of the user, such as the user's name, email address, and so on. Note that the processing performed to register a user and show a user identifier and a password to the user in response to a user registration instruction is a well-known technique.

Any input means, such as a touch panel, a keyboard, a mouse, a menu screen, or the like, may be employed to input instructions, information, and so on. The acceptance unit 12 can be realized using a device driver for the input means such as a touch panel or a keyboard, or control software or the like for controlling the menu screen.

The operation acceptance unit 121 accepts one or more operations performed on a web page. Note that accepting an operation may be considered to be the same as accepting operation information.

The “acceptance” here is a concept that includes acceptance of information input from an input device such as a keyboard, a mouse, or a touch panel, reception of information transmitted via a wired or wireless communication network, or acceptance of information read from a recording medium such as an optical disk, a magnetic disk, or a semiconductor memory.

The processing unit 13 performs various kinds of processing. Examples of the various kinds of processing include the processing that is performed by the page access unit 131, the condition accumulation unit 132, the management information acquisition unit 133, the management information accumulation unit 134, the judgment unit 135, and the action unit 136. Examples of the various kinds of processing include processing that is performed to change the instructions, information, and so on accepted by the acceptance unit 12 into data structures of instructions, information, and so on to be transmitted, processing that is performed to change the information received by the reception unit 15 into data structures to be output, and so on.

The page access unit 131 accesses the web server to acquire web pages. The page access unit 131 accesses the web server corresponding to the web page identified by the page identifier received by the acceptance unit 12, and acquires the web page. Note that the web server is, for example, a server device 2.

The condition accumulation unit 132 accumulates action conditions received by the condition reception unit 151. The condition accumulation unit 132 accumulates action conditions in pairs with processing identifiers, for example. The condition accumulation unit 132 may accumulate dynamic processing information that contains the action conditions received by the condition reception unit 151 and the processing identifiers.

The management information acquisition unit 133 acquires one or more pieces of management information corresponding to the one or more operations accepted by the operation acceptance unit 121. Management information is a set of one or more pieces of operation information or dynamic attribute values.

The management information acquisition unit 133 acquires one or more pieces of operation information from the one or more operations accepted by the operation acceptance unit 121. The management information acquisition unit 133 acquires, for example, one or more pieces of operation information from the one or more operations accepted by the operation acceptance unit 121, and acquires dynamic attribute values using the one or more pieces of operation information.

The management information acquisition unit 133 acquires, for example, one or more dynamic attribute values in association with websites of web pages, using one or more pieces of operation information. The management information acquisition unit 133 acquires, for example, the stay time on the website or web page, the number of purchases of products corresponding to the website, the purchase amount, the total purchase amount, the number of PVs, the average stay time, and the number of visits. Note that the number of PVs is the number of page views.

The management information acquisition unit 133 constantly acquires information regarding the browsing by the users visiting the website, for example. Examples of information regarding browsing include the stay time on the website or the web page, the number of browsed pages, and so on. That is to say, for example, the management information acquisition unit 133 constantly measures the stay time of a user visiting a website, on the website or the web page. In addition, the management information acquisition unit 133 updates the user's dynamic attribute value based on the accepted operation.

Using two or more pieces of information out of one or more attribute values of the user who uses the terminal device 1 and one or more pieces of operation information, the management information acquisition unit 133 calculates the score of the user. Note that there is no limitation on the time at which the management information acquisition unit 133 calculates the score. For example, the management information acquisition unit 133 may calculate a score each time operation information is acquired, or calculate a score when predetermined operation information is acquired, or calculate a score at a predetermined time. Note that the predetermined operation information is, for example, operation information related to dynamic attribute values used to calculate a score, such as operation information indicating that a product has been purchased, or operation information indicating a login instruction.

For example, the management information acquisition unit 133 uses an increasing function having, as parameters, one or more pieces of information out of the stay time on the acquired website or web page, the number of purchases, the purchase amount, the total purchase amount, the number of PVs, the average stay time, and the number of visits, to acquire a score. For example, the management information acquisition unit 133 uses a function having, as parameters, the stay time per a predetermined period, the number of purchases per predetermined period, the purchase amount per predetermined period, the number of PVs per predetermined period, the average stay time per predetermined period, and the number of visits per predetermined period, to calculate a score. For example, the management information acquisition unit 133 uses a decreasing function having, as parameters, the elapsed time from the previous visit, to calculate a score. Alternatively, instead of a function, the management information acquisition unit 133 may use a correspondence table in which conditions using one or more parameters such as the stay time, the number of purchases, the purchase amount, the total purchase amount, the number of PVs, the average stay time, the number of visits, and so on correspond to scores, to acquire a score. There is no limitation on the method or algorithm used by the management information acquisition unit 133 to acquire a score. Note that the score is, for example, information indicating the degree of importance of the user from the perspective of the administrator.

It is preferable that the management information acquisition unit 133 acquires updated management information using the management information stored in the management information storage unit 111 and one or more pieces of operation information.

For example, in the case where the number of visits “10” to a website is stored in the management information storage unit 111, when the management information acquisition unit 133 detects that the website has been visited, based on the accepted operation information, the management information acquisition unit 133 acquires a new number of visits “11”.

For example, in the case where the total purchase amount on a website is stored in the management information storage unit 111, when the management information acquisition unit 133 detects that a product has been purchased from the website, based on the accepted operation information, the management information acquisition unit 133 acquires information regarding the price of the currently purchased product, adds the price to the stored total purchase amount, and acquires a new total purchase amount.

For example, in the case where the average stay time and the number of visits to a website are stored in the management information storage unit 111, and when the management information acquisition unit 133 detects that a user has visited the website and then left the website, based on the accepted operation information, the management information acquisition unit 133 acquires the current stay time, and acquires a new average stay time, using the current stay time, and the average stay time and the number of visits stored in the management information storage unit 111. The management information acquisition unit 133 increments the number of visits stored in the management information storage unit 111 by one to acquire a new number of visits.

The management information storage unit 134 accumulates the management information acquired by the management information acquisition unit 133 in association with a page identifier that identifies the operation-target web page or website. For example, the management information accumulation unit 134 accumulates management information in the management information storage unit 111, but the management information accumulation unit 134 may accumulate management information in an external device (not shown).

It is preferable that the management information accumulation unit 134 accumulates only management information that meets a predetermined accumulation condition. The accumulation condition is, for example, that the management information is that used in an action condition. Examples of accumulation conditions include “score”, “number of purchases of products”, and “total purchase amount”. The accumulation condition is, for example, that the management information is that stored in the storage unit 11.

It is preferable that the management information accumulation unit 134 accumulates management information in association with a browser that outputs a web page. When two or more browsers are used in one terminal device 1, it is preferable that the management information accumulation unit 134 accumulates management information in association with the browser used to operate the web page. Association with the browser may be association with the identifier of the browser, or may be accumulation in a storage area (for example, a specific folder) used by the browser. Association with a bowser need only make it possible for the browser to use management information. Note that the browser is, for example, Microsoft Edge, Google Chrome, or the like, but there is no limitation.

The judgment unit 135 judges whether or not the management information acquired by the management information acquisition unit 133 meets the action condition. Note that there is no limitation on the time at which the management information acquisition unit 133 acquires management information. In addition, there is no limitation on the time at which the judgment unit 135 performs the above-described judgment processing. However, it is preferable that the judgment unit 135 performs the above-described judgment processing every time the management information acquisition unit 133 acquires management information. The judgment unit 135 may periodically perform the above-described judgment processing.

When the judgment unit 135 judges that the management information meets an action condition, the action unit 136 performs an action corresponding to the action condition. When the judgment unit 135 judges that the management information meets an action condition, the action unit 136 acquires a processing identifier paired with the action condition, and executes an action identified by the processing identifier. Note that the action is, for example, screen change processing. The screen change processing is, for example, processing in which the web page that is being output is changed, or processing in which another screen (window) is output on top of the web page that is output. The action is, for example, communication processing that is performed to start communication with another terminal device. Communication processing is, for example, chat processing that is performed to start a chat with another terminal device, video conference processing that is performed to start a video conference with another terminal device, or voice call processing that is performed to start a voice call with another terminal device. That is to say, the means for communication may be character strings, audio, video, or the like, and there is no limitation. Note that the other terminal device is, for example, a management terminal 3, but may be another terminal device 1.

If the action is communication processing, the action unit 136 executes, for example, communication processing with the management terminal 3 corresponding to the operation-target website or web page. The administrator using the management terminal 3 can provide customer service to the user of the terminal device 1. Note that the management terminal identifier identifying the communication-target management terminal 3 is managed in association with, for example, a processing identifier or an action condition. The management terminal identifier is, for example, the IP address of the management terminal 3, the MAC address of the management terminal 3, a telephone number, or the ID of an application for video conferences, chats, and the like.

The transmission unit 14 transmits various kinds of information, instructions, and so on. Examples of the various kinds of information, instructions, and so on include management information, operation information, a login instruction, a user registration instruction, and so on. The transmission unit 14 typically transmits information, instructions, and so on to a server device 2. The transmission unit 14 may transmit user attribute values in addition to management information. Note that user attribute values are stored in the storage unit 11 and are static attribute values or dynamic attribute values.

The transmission unit 14 may transmit information, instructions, and so on to a second server device (not shown). In such a case management information and so on are transmitted from the second server device to the server device 2. The second server device will be described later.

The management information transmission unit 141 transmits one or more pieces of management information stored in the management information storage unit 111 to the server device 2.

It is preferable that the management information transmission unit 141 transmits management information to the server device 2 only when a predetermined transmission condition is satisfied. Examples of transmission conditions include a condition that is based on management information, a condition that is based on timing, and so on. Examples of conditions that are based on management information include a condition that is based on a dynamic attribute value of the user. Examples of conditions that are based on a dynamic attribute value of the user include “the score is no less than a threshold value”. “the number of visits is greater than a threshold value”, “the total purchase amount is no less than a threshold value”, and so on. Examples of conditions that are based on timing include “a specific web page or a specific website is accessed”.

The reception unit 15 receives various kinds of information. Examples of the various kinds of information include an action condition, a processing result, and a login processing result. The processing result is information regarding the result of the processing performed by the response unit 232, which will be described later. Examples of processing results include an output web page (destination web page), a panel on which the result of an instruction to purchase a product is described, an error message, and so on. Examples of login processing include information indicating whether the login processing was successful or unsuccessful, information regarding the web page after login, and so on. The reception unit 15 typically receives various kinds of information from a server device 2. The reception unit 15 may receive information such as a web page from a web server other than the server device 2.

The condition reception unit 151 receives action conditions. The condition reception unit 151 typically receives action conditions from a server device 2. The condition reception unit 151 receives, for example, dynamic processing information containing an action condition and a processing identifier. It is preferable that the condition reception unit 151 receives action conditions from a server device 2 in response to access to the server device 2. The server device 2 is typically a web server.

The output unit 16 outputs various kinds of information. The various kinds of information are, for example, pieces of information received by the reception unit 15 and changed by the processing unit 13 so as to have a structure that is to be output, and examples thereof include a processing result and a login processing result. Examples of the various kinds of information include a web page and an action condition.

Here, “output” is a concept that encompasses displaying on a display screen, projection using a projector, printing by a printer, the output of a sound, transmission to an external device, accumulation on a recording medium, delivery of a processing result to another processing device or another program, and the like.

The page output unit 161 outputs a web page in response to access. The page output unit 161 outputs a web page received by the reception unit 15.

The server storage unit 21 included in the server device 2 stores various kinds of information. Examples of the various kinds of information include user information, which will be described later, an action condition, dynamic processing information, operation information, information regarding an arithmetic expression information used to calculate scores, a validity condition, which will be described later, and a server transmission condition, which will be described later.

The user information storage unit 211 stores one or more pieces of user information. Each piece of user information is information regarding a user, and contains one or more attribute values. Also, each piece of user information is, for example, information regarding a registered user. The one or more attribute values are typically static attribute values, but may include a dynamic attribute value.

The server condition storage unit 212 stores one or more action conditions. The server condition storage unit 212 may store one or more pieces of dynamic processing information. Each piece of dynamic processing information contains an action condition and a processing identifier. Each piece of dynamic processing information may also contain information specifying a processing timing.

The server reception unit 22 receives various kinds of information, instructions, and so on. Examples of the various kinds of information, instructions, and so on include a login instruction, management information, operation information, and a user registration instruction.

The login instruction reception unit 221 receives a login instruction from a terminal device 1. The login instruction is an instruction to log in.

The server management reception unit 222 receives management information from the terminal device 1 of the user who is a visitor to the website. The server management reception unit 222 need not directly receive management information from the terminal device 1. The server management reception unit 222 may receive management information that is based on information input from the terminal device 1, from the second server device, which will be described later.

It is preferable that the server management reception unit 222 receives management information as infrequently as possible. The server management reception unit 222 may receive only some pieces of management information of the two or more pieces of management information stored in the terminal device 1.

The server processing unit 23 performs various kinds of processing. Examples of the various kinds of processing include the processing that is performed by the login processing unit 231, the response unit 232, the server management accumulation unit 233, the attribute value acquisition unit 234, and the server inspection unit 235.

The server processing unit 23 performs user registration processing according to a user registration instruction that has been received. User registration processing is, for example, processing in which a unique user identifier and password are generated, and user information containing the user identifier, password, and the one or more attribute values contained in the user registration instruction, is accumulated in the user information storage unit 211. User registration processing is, for example, processing that is performed to transmit the generated user identifier and password to the terminal device 1. Note that user registration processing is well-known processing.

The login processing unit 231 executes login processing for a user of the terminal device 1 in response to the login instruction that has been received. Note that the execution of login processing is a well-known technique, and therefore the detailed description thereof will be omitted. In addition, it is assumed that the execution of the login processing typically includes transmission of the result of the login processing to the terminal device 1. The login processing unit 231 typically permits login and enables communication with the terminal device 1 if a valid user identifier or the like is received. The login processing unit 231 typically prohibits login and transmits an error message to the terminal device 1 if an invalid user identifier or the like is received.

The response unit 232 performs processing according to operation information that has been received. Examples of the processing according to the operation information include the transmission of a web page corresponding to the operation information, processing that is performed to purchase a product corresponding to the operation information, payment processing corresponding to the operation information, and so on. Any processing may be performed as long as it follows the operation information.

The response unit 232 performs processing and acquires a processing result. Note that examples of processing results include a destination web page, a panel on which the result of an instruction to purchase a product is described, an error message, and so on. The processing performed by the response unit 232 is a well-known technique, and therefore the detailed description thereof will be omitted.

The server management accumulation unit 233 accumulates the management information received by the server management reception unit 222 in the server storage unit 21 in pairs with user identifiers. For example, the server management accumulation unit 233 accumulates the management information received by the server management reception unit 222 in the server storage unit 21 in pairs with user identifiers contained in login instructions.

The attribute value acquisition unit 234 acquires one or more attribute values of the user visiting the website. Here, the one or more attribute values may include the above-described static attribute values and dynamic attribute values. The attribute value acquisition unit 234 acquires one or more attribute values of the user visiting the website, using one or more pieces of management information that have been received. The attribute value acquisition unit 234 typically acquires one or more static attribute value from the user information storage unit 211. The attribute value acquisition unit 234 typically receives one or more dynamic attribute values, using one or more pieces of operation information that have been received.

The attribute value acquisition unit 234 acquires one or more dynamic attribute values that are attribute values that dynamically change, using the one or more pieces of management information received by the server management reception unit 222.

For a user, the score calculation part 2341 calculates a score of the user, using one or more pieces of information out of one or more attribute values of the user and one or more pieces of management information received by the server management reception unit 222 from the terminal device 1 of the user.

For example, the score calculation part 2341 calculates a score using an increasing function that has, as parameters, one or more pieces of information out of the stay time on the website or web page, the number of purchases, the purchase amount, the total purchase amount, the number of PVs, the average stay time, and the number of visits, acquired by the attribute value acquisition unit 234.

The server inspection unit 235 judges whether or not the management information received by the server management reception unit 222 is valid. The judgment regarding whether or not the management information is valid is typically a judgment regarding whether or not the management information has been tampered with by the terminal device 1.

For example, the server inspection unit 235 judges whether or not the received management information is valid by comparing the management information received in association with a user identifier and the management information stored in pair with the user identifier.

For example, using the management information received in association with the user identifier, the server inspection unit 235 judges whether or not the management information meets the validity condition. The validity condition is, for example, in the case where “score=f(total purchase amount, number of purchases)” and the score has been tampered with by the terminal device 1, the server inspection unit 235 uses management information containing the score, the total purchase amount, and the number of purchases that have been 10 received, to detect whether or not the management information meets “score=f(total purchase amount, number of purchases)”.

For example, using the management information received in association with the user identifier and the management information stored in pair with the user identifier, the server inspection unit 235 judges whether or not the received management information meets the validity condition. The validity condition is, for example, that “the score received in association with the user identifier—the score stored in pair with the user identifier <=a threshold value”. Such a validity condition is a condition used to detect that the score has been tampered with when the score exceeds the limit in the case where management information is transmitted periodically (for example, once a month) from the terminal device 1, and there is a limit that the score should not increase by an amount no less than a threshold value within a predetermined period (for example, one month).

The server transmission unit 24 transmits one or more action conditions to the terminal device 1. For example, the server transmission unit 24 transmits one or more pieces of dynamic processing information each containing an action condition and a processing identifier to the terminal device 1.

It is preferable that the server transmission unit 24 transmits an action condition to the terminal device 1 when management information satisfies a predetermined server transmission condition. The server transmission condition is, for example, a condition related to dynamic attribute values. The server transmission condition is, for example, a condition related to timing. Examples of the server transmission condition related to the content of management information include “the number of visits has reached a threshold value”, “the score has reached a value no less than a threshold value”, “the total purchase amount has reached a value no less than a threshold value”, and so on. Examples of the server transmission condition related to timing include “operation information indicating login has been received”, “every time a web page is accessed”, “the access is the second or later access in the day”, and so on.

The server output unit 25 outputs the result of the judgment by the server inspection unit 235. For example, the server output unit 25 outputs the result of the judgment by the server inspection unit 235 to the terminal device 1. For example, the server output unit 25 accumulates the results of the judgment by the server inspection unit 235 in the server storage unit 21 in association with user identifiers. For example, the server output unit 25 transmits the results of the judgment by the server inspection unit 235 to a management terminal 3 in association with user identifiers.

The management storage unit 31 included in the management terminal 3 stores various kinds of information. Examples of the various kinds of information include an administrator identifier identifying an administrator.

The management acceptance unit 32 accepts various kinds of instructions, information, and so on. Examples of the various kinds of instructions, information, and so on include an action condition, dynamic processing information, and input information used to communicate with users. The input information is, for example, chat information, audio of a video conference, or the like. Note that the action condition and the dynamic processing information accepted by the management acceptance unit 32 are transmitted to the server device 2 and are accumulated in the server device 2.

Any input means, such as a touch panel, a keyboard, a mouse, a menu screen, or the like, may be employed to input various kinds of instructions, information, and so on. The management acceptance unit 32 can be realized using a device driver for the input means such as a touch panel or a keyboard, or control software or the like for controlling the menu screen.

The management processing unit 33 performs various kinds of processing. Examples of the various kinds of processing include processing that is performed by the management acceptance unit 32 to change the structure of the received instruction, information, and so on to the structure of data to be transmitted, processing that is performed by the management reception unit 35 to change the structure of the received information to the structure of data to be output, and so on.

The management transmission unit 34 transmits various kinds of instructions, information, and so on. The management transmission unit 34 typically transmits various kinds of instructions, information, and so on to a server device 2 or a terminal device 1. Examples of the various kinds of instructions, information, and so on include an action condition, dynamic processing information, and input information used to communicate with users.

The management reception unit 35 receives various kinds of information. For example, the management reception unit 35 receives various kinds of information from a server device 2. The various kinds of information are, for example, one or more attribute values of each user. For example, the management reception unit 35 receives information from a terminal device 1. The information from the terminal device 1 is, for example, input information that is used to perform communication (for example, character strings for a chat, a voice of the user) transmitted from the user.

The management output unit 36 outputs various kinds of information. The various kinds of information are, for example, one or more attribute values of each user and input information.

It is preferable that the storage unit 11, the management information storage unit 111, the condition storage unit 112, the server storage unit 21, the user information storage unit 211, the server condition storage unit 212, and the management storage unit 31 are realized using a non-volatile recording medium, but they may be realized using a volatile recording medium.

There is no limitation on the process in which information is stored in the storage unit 11 or the like. For example, information may be stored in the storage unit 11 or the like via a recording medium, or information transmitted via a communication line or the like may be stored in the storage unit 11 or the like, or information input via an input device may be stored in the storage unit 11 or the like.

The processing unit 13, the page access unit 131, the condition accumulation unit 132, the management information acquisition unit 133, the management information accumulation unit 134, the judgment unit 135, the action unit 136, the server processing unit 23, the login processing unit 231, the response unit 232, the server management accumulation unit 233, the attribute value acquisition unit 234, the server inspection unit 235, the attribute value acquisition unit 234, the score calculation part 2341 and the management processing unit 33 can typically be realized using a processor, a memory, or the like. The processing procedures performed by the processing unit 13 and so on are typically realized using software, and the software is recorded on a recording medium such as a ROM. However, the processing unit 13 and so on may be realized using hardware (a dedicated circuit). Note that the processor may be an MPU, a CPU, a GPU, or the like, and there is no limitation.

The transmission unit 14, the management information transmission unit 141, the server transmission unit 24, and the management transmission unit 34 are typically realized using a wireless or wired communication means.

The reception unit 15, the condition reception unit 151, the server reception unit 22, the login instruction reception unit 221, the server management reception unit 222, and the management reception unit 35 are typically realized using a wireless or wired communication means.

The output unit 16, the page output unit 161, the server output unit 25, and the management output unit 36 may be regarded as including or not including an output device such as a display or a speaker. The output unit 16 and so on can be realized using the driver software of the output device, the driver software of the output device and the output device, or the like.

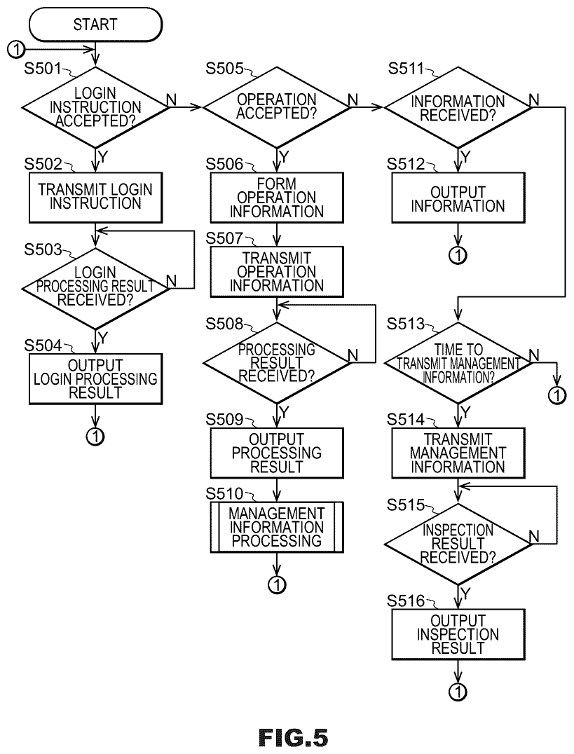

Next, an operation example of the information system A will be described. First, an operation example of a terminal device 1 will be described with reference to the flowchart in FIG. 5.

(Step S501) The acceptance unit 12 judges whether or not a login instruction has been accepted. If a login instruction has been accepted, processing proceeds to step S502, and if a login instruction has not been accepted, processing proceeds to step S505.

(Step S502) The processing unit 13 forms a login instruction to be transmitted, using the login instruction accepted in step S501. The transmission unit 14 transmits the login instruction to the server device 2.

(Step S503) The reception unit 15 judges whether or not the result of login processing has been received. If the result of login processing has been received, processing proceeds to step S504, and if the result of login processing has not been received, processing returns to step S503.

(Step S504) The output unit 16 outputs the result of login processing received in step S503. Processing returns to step S501.

(Step S505) The acceptance unit 12 judges whether or not an operation has been accepted from the user. If an operation has been accepted, processing proceeds to step S506, and if an operation has not been accepted, processing proceeds to step S511.

(Step S506) The processing unit 13 forms operation information based on the operation accepted in step S505.

(Step S507) The transmission unit 14 transmits the operation information formed in step S506 to a web server. It is preferable that the web server is, for example, the second server device described later, but may be a server device 2. If the operation information is to be transmitted to the second server device, the server device 2 typically does not include the response unit 232.

(Step S508) The reception unit 15 judges whether or not a processing result corresponding to the operation information has been received from the web server. If a processing result has been received, processing proceeds to step S509, and if a processing result has not been received, processing returns to step S508.

(Step S509) The output unit 16 outputs the processing result received in step S508.

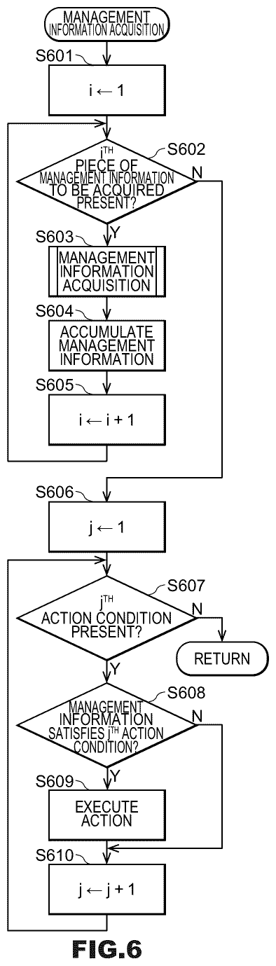

(Step S510) The management information acquisition unit 133 and so on performs processing related to management information. Processing returns to step S501. An example of such management information processing will be described with reference to the flowchart in FIG. 6.

(Step S511) The reception unit 15 judges whether or not information has been received. If information has been received, processing proceeds to step S512, and if information has not been received, processing proceeds to step S513. Note that the reception unit 15 receives information from a web server or a server device 2. Such information is, for example, an action condition.

(Step S512) The output unit 16 outputs the information received in step S511. Processing returns to step S501. Such information is, for example, an action condition. The output is, for example, accumulation in the condition storage unit 112.

(Step S513) The processing unit 13 judges whether or not it is the time to transmit management information. If it is the time to transmit management information, processing proceeds to step S514, and if it is not the time to transmit management information, processing returns to step S501.

(Step S514) The processing unit 13 acquires one or more pieces of management information from the management information storage unit 111. Thereafter, the processing unit 13 acquires a user identifier from the storage unit 11. Next, the management information transmission unit 141 transmits the one or more pieces of management information and the user identifier to the server device 2 in pairs. Note that the management information transmission unit 141 may transmit only a piece of management information that satisfies a predetermined condition of the one or more pieces of management information stored in the management information storage unit 111. Note that the predetermined condition is management information used to perform inspection processing in the server device 2.

(Step S515) In response to the transmission of the management information, the reception unit 15 judges whether or not an inspection result of the management information has been received. If an inspection result has been received, processing proceeds to step S516, and if an inspection result has not been received, processing returns to step S515.

(Step S516) The output unit 16 outputs the inspection result received in step S515. Processing returns to step S501. Note that the output here is, for example, accumulation in the storage unit 11, or display on the display.

In the flowchart in FIG. 5, if communication with the terminal device 3 is started by the execution of the action included in the management information processing in step S510, the terminal device 1 accepts information from the user (for example, chat text, web conference audio, and so on) and transmits the information to the management terminal 3. The terminal device 1 receives and outputs information (for example, chat text, web conference audio, etc.) transmitted from the management terminal 3.

In addition, in the flowchart in FIG. 5, when the terminal device 1 communicates with the management terminal 3, for example, the management information transmission unit 141 may read out one or more pieces of management information from the management information storage unit 111 and transmit them to the management terminal 3. In such a case, the management terminal 3 receives and outputs the one or more pieces of management information. As a result, the management terminal 3 can communicate with the user while viewing the attribute values of the user (for example, the score and so on).

In the flowchart in FIG. 5, after the result of the login processing is output, the management information processing in step S510 may be performed.

Furthermore, in the flowchart in FIG. 5, processing ends when the power is turned off or an interruption occurs to end the processing.

Next, an example of the management information processing in step S510 will be described with reference to the flowchart in FIG. 6.

(Step S601) The management information acquisition unit 133 substitutes 1 for a counter i.

(Step S602) The management information acquisition unit 133 judges whether or not the i^{th} piece of management information to be acquired is present. If the i^{th} piece of management information is present, processing proceeds to step S603, and if the i^{th} piece of management information is not present, processing proceeds to step S606. Note that, for example, the management information acquisition unit 133 judges whether or not the i^{th} management information used by one or more action conditions stored in the condition storage unit 112 is present. If information that specifies all the pieces of management information used by one or more action conditions stored in the condition storage unit 112 has been stored in the storage unit 11 in advance, the management information acquisition unit 133 references the storage unit 11 to judge whether or not the i^{th} piece of management information to be acquired is present.

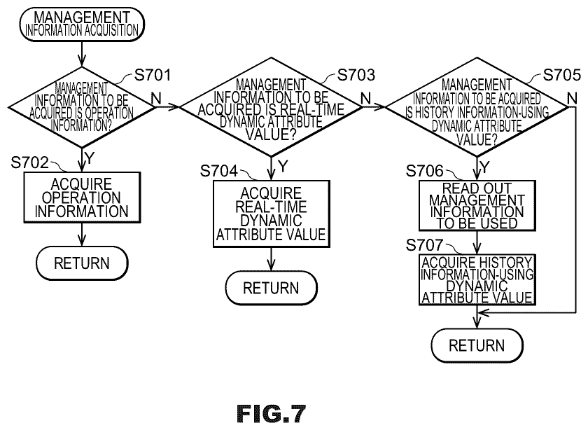

(Step S603) The management information acquisition unit 133 performs processing to acquire the i^{th} piece of management information. An example of such management information acquisition processing will be described with reference to the flowchart in FIG. 7.

(Step S604) The management information accumulation unit 134 accumulates the i^{th} piece of management information acquired in step S603 in the management information storage unit 111 in association with the operation-target web page or web site.

(Step S605) The management information acquisition unit 133 increments the counter i by 1. Processing returns to step S602.

(Step S606) The judgment unit 135 substitutes 1 for a counter j.

(Step S607) The judgment unit 135 judges whether or not the j^{th} action condition is present in the condition storage unit 112. If the j^{h} action condition is present, processing proceeds to step S608, and if the j^{th} action condition is not present, processing returns to higher-level processing.

(Step S608) The judgment unit 135 judges whether or not the one or more pieces of management information stored in the management information storage unit 111 meets the j^{th} action condition. If the j^{th} action condition is met, processing proceeds to step S609, and if the j^{th} action condition is not met, processing proceeds to step S610.

(Step S609) The action unit 136 acquires a processing identifier that is paired with the j^{th} action condition from the condition storage unit 112. The action unit 136 executes the action identified by the processing identifier.

(Step S610) The judgment unit 135 increments the counter j by 1. Processing returns to step S607.

Needless to say, in the flowchart in FIG. 6, the processing from step S606 to step S610 may be performed before the processing from step S601 to step S605.

Next, an example of the management information acquisition processing in step S603 will be described with reference to the flowchart in FIG. 7.

(Step S701) The management information acquisition unit 133 judges whether or not the management information to be acquired is operation information. If the management information is operation information, processing proceeds to step S702, and if the management information is not operation information, processing proceeds to step S703.

(Step S702) The management information acquisition unit 133 acquires operation information corresponding to the operation accepted in step S505. Processing returns to higher-level processing.

(Step S703) The management information acquisition unit 133 judges whether or not the management information to be acquired is a real-time dynamic attribute value. If the management information is a real-time dynamic attribute value, processing proceeds to step S704, and if the management information is not a real-time dynamic attribute value, processing proceeds to step S705.

(Step S704) The management information acquisition unit 133 acquires the real-time dynamic attribute value that is the management information to be acquired. Processing returns to higher-level processing. Examples of real-time dynamic attribute values include the stay time of the user on the web page that the user is currently viewing and the number of web pages viewed during the current stay.

(Step S705) The management information acquisition unit 133 judges whether or not the management information to be acquired is a history information-using dynamic attribute value. If the management information is a history information-using dynamic attribute value, processing proceeds to step S706, and if the management information is not a history information-using dynamic attribute value, processing returns to higher-level processing.

(Step S706) The management information acquisition unit 133 acquires the management information to be used to acquire the history information-using dynamic attribute value, from the management information storage unit 111.

(Step S707) The management information acquisition unit 133 acquires the updated history information-using dynamic attribute value, using the one or more pieces of management information read out in step S706 and the operation information corresponding to the operation accepted in step S505. Processing returns to higher-level processing. Examples of history information-using dynamic attribute values include the number of purchases, the purchase amount, the total purchase amount, the average stay time, the average number of PVs, the number of visits, and the score.

Note that, in the flowchart in FIG. 7, the dynamic attribute values that can be acquired through constant monitoring during the visit to a web page or a website are acquired by the management information acquisition unit 133 by performing constant monitoring. Examples of such dynamic attribute values include the stay time on a web page, the number of web pages browsed during the current visit, and so on.

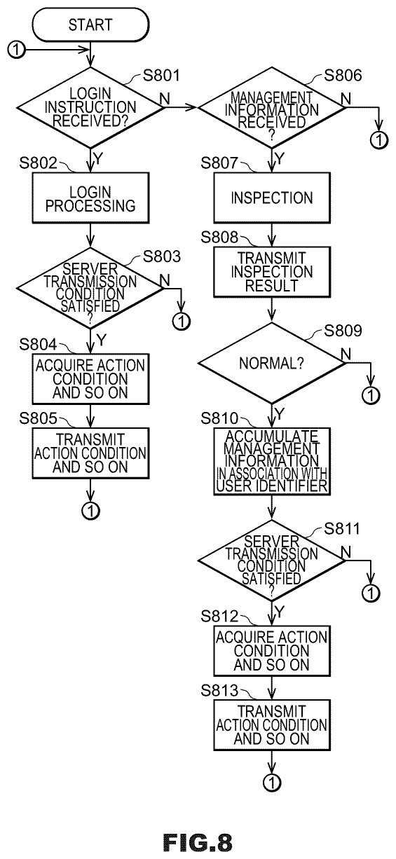

Next, an operation example of a server device 2 will be described with reference to the flowchart in FIG. 8.

(Step S801) The login instruction reception unit 221 judges whether or not a login instruction has been received from a terminal device 1. If a login instruction has been received, processing proceeds to step S802, and if a login instruction has not been received, processing proceeds to step S806.

(Step S802) The login processing unit 231 executes login processing for the user of the terminal device 1 in response to the login instruction that has been received. Note that the execution of the login processing typically includes transmission of the result of the login processing to the terminal device 1.

(Step S803) The server processing unit 23 judges whether or not the result of the login processing satisfies a server transmission condition. If the server transmission condition is satisfied, processing proceeds to step S804, and if the server transmission condition is not satisfied, processing returns to step S801. Note that the case in which the result of the login processing satisfies the server transmission condition typically means that the login processing was performed normally. In addition, here, if one or more server transmission conditions are stored in the server condition storage unit 212, the server processing unit 23 typically judges whether or not the result of the login processing satisfies any of the server transmission conditions.

(Step S804) The server processing unit 23 acquires an action condition and a processing identifier corresponding to the login processing, from the server condition storage unit 212.

(Step S805) The server transmission unit 24 transmits the action condition and the processing identifier acquired in step S804 to the terminal device 1. Processing returns to step S801.

(Step S806) The server management reception unit 222 judges whether or not one or more pieces of management information have been received from the terminal device 1. If one or more pieces of management information have been received, processing proceeds to step S807, and if one or more pieces of management information have not been received, processing returns to step S801. Note that one or more pieces of management information are typically received in pair with the user identifier.

(Step S807) The server inspection unit 235 judges whether or not the one or more pieces of management information received in step S806 are normal. Thereafter, the server inspection unit 235 acquires the inspection result (for example, normal “1” or abnormal “0”).

(Step S808) The server transmission unit 24 transmits the inspection result acquired in step S807 to the terminal device 1.

(Step S809) The server management accumulation unit 233 judges whether or not the inspection result acquired in step S807 is “normal”. If the inspection result is “normal”, processing proceeds to step S810, and if the inspection result is not “normal”, processing returns to step S801.

(Step S810) The server management accumulation unit 233 accumulates the one or more pieces of management information that have been received, in the user information storage unit 211, in pair with the user identifier.

(Step S811) The server processing unit 23 judges whether or not the one or more pieces of management information that have been received satisfies the server transmission condition. If the server transmission condition is satisfied, processing proceeds to step S812, and if the server transmission condition is not satisfied, processing returns to step S801. In addition, here, if one or more server transmission conditions are stored in the server condition storage unit 212, the server processing unit 23 typically judges whether or not the one or more pieces of management information satisfy any of the server transmission conditions.

(Step S812) The server processing unit 23 acquires the action condition and the processing identifier corresponding to the satisfied server transmission condition, from the server condition storage unit 212.

(Step S805) The server transmission unit 24 transmits the action condition and the processing identifier acquired in step S812 to the terminal device 1. Processing returns to step S801.

In the flowchart in FIG. 8, if the server device 2 also functions as a web server, the server reception unit 22 receives operation information, and the response unit 232 performs processing corresponding to the received operation information. Note that the device that realizes the function of receiving operation information and performing processing corresponding to the received operation information is not limited to the server device 2, and may be the second server device described later. In such a case, the server device 2 does not include the response unit 232.

Furthermore, in the flowchart in FIG. 8, processing ends when the power is turned off or an interruption occurs to end the processing.

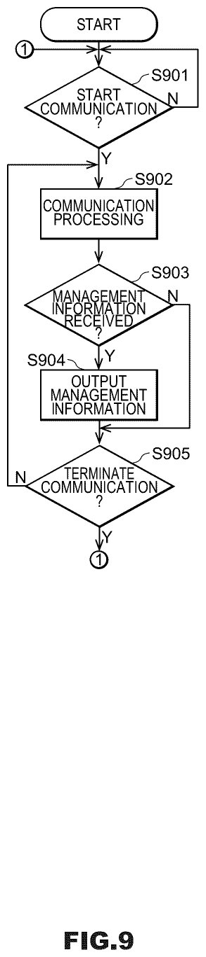

Next, an operation example of a management terminal 3 will be described with reference to the flowchart in FIG. 9.

(Step S901) The management processing unit 33 judges whether or not to start communication with the terminal device 1. If communication is to be started, processing proceeds to step S902, and if communication is not to be started, processing returns to step S901.

(Step S902) The management processing unit 33 performs processing to start communication.

(Step S903) The management reception unit 35 judges whether or not the one or more pieces of management information transmitted from the terminal device 1 have been received. If the one or more pieces of management information have been received, processing proceeds to step S904, and if the one or more pieces of management information have not been received, processing returns to step S905.

(Step S904) The management output unit 36 outputs the one or more pieces of management information received in step S903.

(Step S905) The management processing unit 33 judges whether or not to terminate the communication. If the communication is to be terminated, processing returns to step S901, and if the communication is not to be terminated, processing proceeds to step S902. Note that when the communication is to be terminated is, for example, when the management acceptance unit 32 accepts a termination instruction, or when the management reception unit 35 receives a termination instruction transmitted from a terminal device 1.

Furthermore, in the flowchart in FIG. 9, processing ends when the power is turned off or an interruption occurs to end the processing.

Hereinafter, specific operation examples of the information system A according to the present embodiment will be described. The present specific examples describe processing that is performed to purchase products on an EC site, and processing that is performed to, for example, browse web pages.

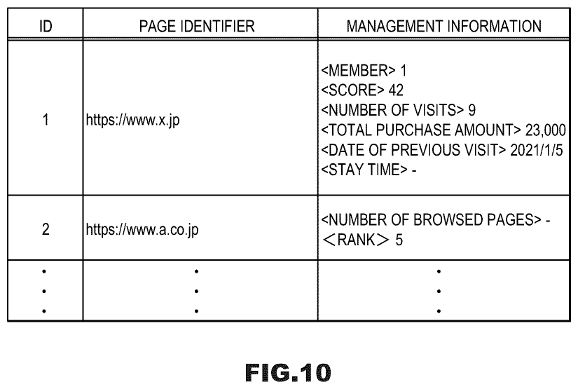

Now, for example, it is assumed that the management information management table shown in FIG. 10 is stored in the management information storage unit 111 of the terminal device 1 of a user A (A-o Yamada). It is assumed that the management information management table in FIG. 10 is a management table compatible with a browser X. Although not shown in the drawing, it is assumed that the management information storage unit 111 also stores a management information management table compatible with a browser Y. The management information management table is a table for managing one or more records each containing “ID”, “page identifier”, and “management information”. The “ID” is information identifying the record. The “page identifier” here is a URL. The “management information” here contains one or more dynamic attribute values and one or more static attribute values. Each attribute value is paired with an attribute value identifier, which is information (here, a tag) that identifies the attribute value.

The record with “ID=1” in FIG. 10 manages management information that is used when the user performs an operation on a web site (an EC site in this example) identified by the page identifier “https://www.x.jp”, using the browser X.

The record with “ID=2” in FIG. 10 manages management information that is used when the user performs an operation on a web site identified by the page identifier “https://www.a.co.jp”, using the browser X.

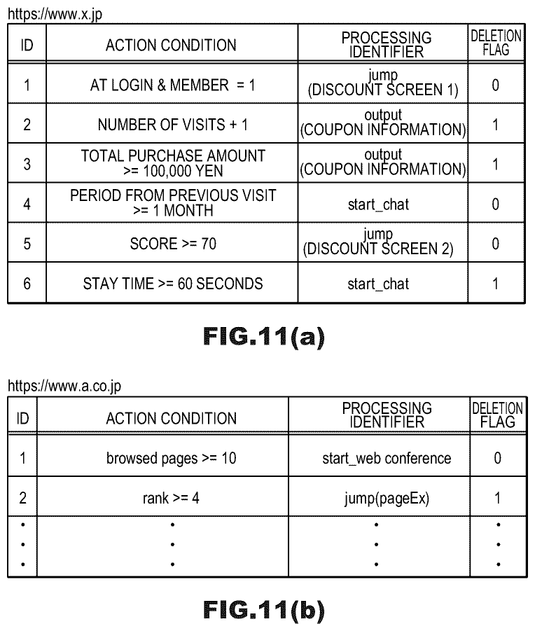

It is also assumed that the condition storage unit 112 of the terminal device 1 of the user A stores the dynamic processing information management table shown in FIGS. 11(a) and (b). The dynamic processing information management table is a table for managing one or more records each containing “ID”, “action condition”, a “processing identifier”, and “deletion flag”. The “ID” is information identifying the record. The “deletion flag” is information indicating whether or not the record containing an action condition is to be deleted when the action condition is satisfied and the processing identified by the processing identifier is executed. It is assumed that a record corresponding to the deletion flag “1” is to be deleted after the processing identified by the processing identifier is executed. It is also assumed that a record corresponding to the deletion flag “0” is not to be deleted even when the processing identified by the processing identifier is executed.

The dynamic processing information management table in FIG. 11(a) is a table corresponding to the web page or web site identified by the page identifier “https://www.x.jp”. The dynamic processing information management table in FIG. 11(b) is a table corresponding to the web page or web site identified by the page identifier “https://www.a.co.jp”.

The action condition “at login & member=1” of the record with “ID=1” in FIG. 11 indicates that it is at the time of login and the value of the member in the static attribute values is “1”. Note that the condition “at login” that constitutes the action condition is operation information indicating a login instruction or processing result corresponding to the transmission of the login instruction, and is a condition that is satisfied when the processing result received from the website is “permitted”. The processing identifier “jump (discount screen 1)” of the record with “ID=1” is the identifier of the module that performs processing to jump to a discount screen 1. It is assumed that the module “jump” performs processing to jump to a screen (page) identified by an argument. It is also assumed that “discount screen 1” is a page identifier (for example, a URL).

The action condition “number of visits+1” of the record with “ID=2” is a condition that is satisfied when the EC site is visited next time. Such an action condition is a condition that is based on changes in a dynamic attribute value (the number of visits in this example) of the user. Judgment using such a condition that is based on changes in a dynamic attribute value does not require the use of stored management information, making judgment processing simple and fast. The processing identifier “output (coupon information)” of the record with “ID=2” is the identifier of the module that outputs the panel identified by “coupon information”. It is assumed that the module “output” performs processing to output a panel identified by an argument on a screen. It is assumed that “coupon information” is the identifier of a panel.

The action condition “total purchase amount >=100,000 yen” of the record with “ID=3” is a condition that is satisfied when the attribute value “total purchase amount” of the user A is no less than 100,000 yen.

The action condition “period from previous visit >=1 month” of the record with “ID=4” is a condition that is satisfied when it is at the time of login and the difference between the date of login and the attribute value” date of previous visit is no less than 1 month. The processing identifier “start_chat” of the record with “ID=4” is the identifier of the module that starts a chat with the management terminal 3. It is assumed that the module “start_chat” holds a communication destination identifier that is used to perform a chat with the management terminal 3 (for example, the IP address of the management terminal 3, the user ID of the management terminal 3 for the chat application, and so on).

The action condition “score >=70” of the record with “ID=5” is a condition that is satisfied when the attribute value “score” of the user A is 70 or higher.

The action condition “stay time >=60 seconds” of the record with “ID=6” is a condition that is satisfied when the real-time dynamic attribute value “stay time” of the user A is no less than 60 seconds.

Note that the action condition “number of browsed pages >=10” of the record with “ID=1” is FIG. 11(b) is a condition that is satisfied when the number of browsed pages is no less than 10. Note that such a case can be a case in which the user is reluctant to purchase a product. The number of browsed pages is the number of pages browsed within the site during the current visit. The processing identifier “start_web conference” of the record with “ID=1” is the identifier of the processing that is performed to start a web conference (video conference).

The action condition “rank >=4” of the record with “ID=2” in FIG. 11(b) is a condition that is satisfied when the dynamic attribute value “rank” of the user is 4 or higher. It is assumed that the rank is information indicating the user's rank, and is, for example, as with the score, an attribute value that is acquired using one or more attribute values out of “number of visits”, “number of purchases”, “total purchase amount”, and “average number of PVs”.

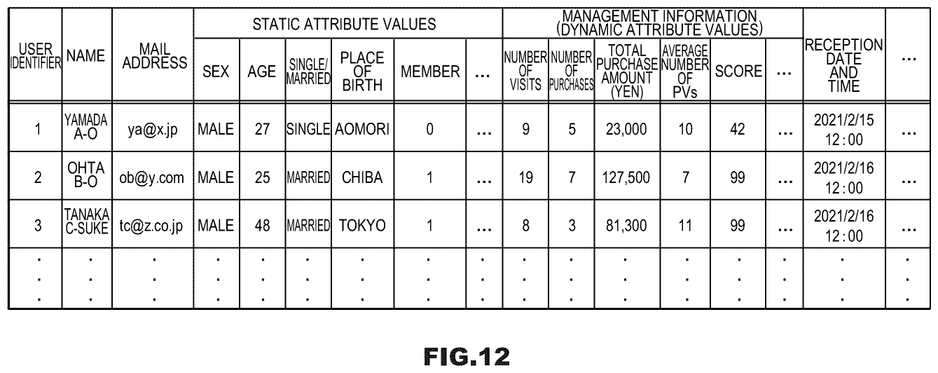

It is assumed that the user information storage unit 211 of the server device 2 stores the user information management table shown in FIG. 12. The user information management table stores records each containing “user identifier”, “name”, “mail address”, “static attribute values”, “management information (dynamic attribute values)”, and “reception date and time”. Note that the user identifier, the name, the mail address, and the static attribute values are pieces of information accumulated in the user information management table at the time of the user registration.

The “static attribute values” here contain “sex”, “age”, “single/married”, “birthplace”, “member”, and so on. “Single/married” is information indicating whether the user is single or married. “Member” indicates whether or not the user is a registered member of this EC site (whether or not the user is a member). Here, the user corresponding to the member value “1” is a member, and the user corresponding to the member value “0” is not a member.

“Management information (dynamic attribute values)” here is history information-using dynamic attribute values, and include “number of visits”, “number of purchases”, “total purchase amount”, “average number of PVs”, “score”, and so on. “Number of visits” is the number of times the user has visited the EC site. “Number of purchases” is the number of times the user has purchased products on the EC site. “Total purchase amount” is the total amount the user has spent on products on the EC site. “Average number of PVs” is the average number of browsed pages per visit of the user. “Score” is the score of the user. Here, it is assumed that the server storage unit 21 stores an arithmetic expression for calculating a score using an increasing function that has, as parameters, one or more attribute values of “number of visits”, “number of purchases”, “total purchase amount”, and “average number of PVs”. It is preferable that this arithmetic expression is an arithmetic expression for calculating a score using one or more pieces of information of the static attribute values. In the case where the member is “1”, the arithmetic expression may an arithmetic expression for performing a calculation so as to increase the value of the score, for example. For example, it is preferable that the arithmetic expression is such that the value of the score is multiplied by 1.1 when the member is “1”, and the value of the score is not changed when the member is “0”.

“Reception date and time” is information indicating the date and time when the server device 2 last received the management information (dynamic attribute values) transmitted from the terminal device 1.

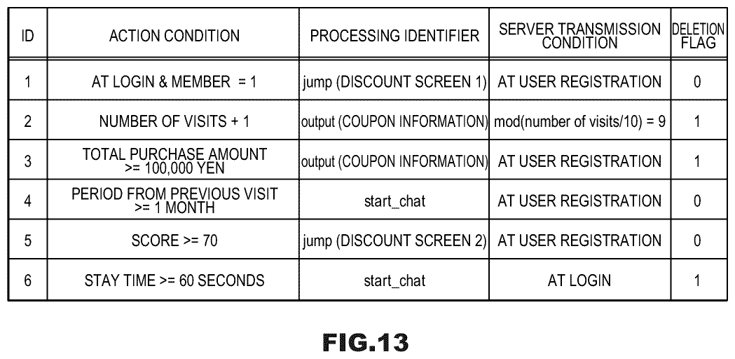

The server condition storage unit 212 stores a server dynamic processing information management table that has the structure shown in FIG. 13. The server dynamic processing information management table stores records each containing “ID”, “action condition”, “processing identifier”, “server transmission condition”, and “deletion flag”. The “ID” is information identifying the record.

The “server transmission condition” is information specifying a condition for transmitting a set consisting of an action condition, a processing identifier, and a deletion flag to the terminal device 1.

The server transmission condition “at user registration” indicates that transmission is performed when user registration processing is performed. That is to say, when user registration processing is performed, sets (four sets) each consisting of an action condition, a processing identifier, and a deletion flag and corresponding to “ID=1, 3, 4, 5” in FIG. 13 are transmitted to the terminal device 1, and are accumulated in the terminal device 1 in association with the page identifiers.

The server transmission condition “mod(number of visits/10)=9” is a condition that is satisfied when the received dynamic attribute value “number of visits” of the user is divided by 10 and the remainder is 9. That is to say, this record allows the user to purchase products at a discount using the discount screen 1 when the number of visits is divisible by 10, such as at the 10th visit, the 20^{th} visit, and so on.

In the dynamic processing information management table, the action condition “at login & member=1” of the record with “ID=1” indicates that it is at the time of login and is a user whose “member” in the static attribute values is “1”.

The server transmission condition “at login” of the record with “ID=6” is a condition that is satisfied when the user logs in. If the stay time is long such as 60 seconds or more, the administrator uses a management terminal 3 to start chatting with the user to assist the user in purchasing products, but the administrator believes that the administrator may change the period of 60 seconds. Therefore, the deletion flag of the record with “ID=6” has been set to “1”.

In such a situation, the following two specific examples will be described. Specific Example 1 is a case in which updated management information is stored in the terminal device 1, and processing identified by a processing identifier paired with a satisfied action condition is executed. Specific Example 2 is a case in which management information is transmitted from the terminal device 1 to the server device 2, and the server device 2 inspects the received management information.

### Specific Example 1

It is assumed that the user A uses the terminal device 1 to give the page identifier “https://www.x.jp” to the browser X, enters the user identifier “1” and so on, and logs in to the EC site.

Next, the terminal device 1 receives a web page of the EC site from the server device 2, and outputs the web page.

Next, the server processing unit 23 of the server device 2 references the server dynamic processing information management table in FIG. 13, and judges that the server transmission condition for “ID=6” is satisfied as it is at login.

Next, the server processing unit 23 of the server device 2 acquires the action condition “stay time >=60 seconds”, the processing identifier “start_chat”, and the deletion flag “1” indicated by “ID=6”, from the server condition storage unit 212.

Next, the server transmission unit 24 transmits the acquired action condition, processing identifier, and deletion flag to the terminal device 1.

Next, the condition reception unit 151 of the terminal device 1 receives the action condition “stay time >=60 seconds”, the processing identifier “start_chat”, and the deletion flag “1”. Next, the condition accumulation unit 132 accumulates the action condition, the processing identifier, and the deletion flag. Such an accumulated record is the record with “ID=6” in FIG. 11(a).

Next, the judgment unit 135 and so on of the terminal device 1 detects a satisfied condition from the action conditions in FIG. 11(a) as follows.

That is to say, the management information acquisition unit 133 acquires management information (member “1” and so on) paired with the page identifier “https://www.x.jp” in FIG. 10. In addition, the management information acquisition unit 133 acquires operation information (for example, “login(URL “https://www.x.jp”, user ID “1”)”) based on the operation by the user A at the login. Thereafter, the judgment unit 135 detects that login processing has been performed, based on the above operation information. Next, the 5 judgment unit 135 judges that the action condition for “ID=1” is met, using the result of the detection of the member “1” and login processing. Next, the action unit 136 acquires the processing identifier “jump (discount screen 1) for “ID=1”. Thereafter, the action unit 136 executes “jump (discount screen 1)”. As a result, the web page of the EC site jumps to the discount screen 1 (a web page where the user can purchase products at a discount).

Next, the action unit 136 acquires the deletion flag “0” for “ID=1”, and judges that the record with “ID=1” is not to be deleted from the table in FIG. 11(a).

Also, since the login has been successful, the judgment unit 135 judges that the action condition “number of visits+1” for “ID=2” is met. Next, the action unit 136 acquires the processing identifier “output (coupon identifier) for “ID=2”. Thereafter, the action unit 136 executes “output (coupon information)”. As a result, coupon information, which is information regarding the coupon to be provided, is output on the screen on which the discount screen 1 has been output.

Next, the action unit 136 acquires the deletion flag “1” for “ID=2”, and deletes the record with “ID=2” from the table in FIG. 11(a).

Also, using the total purchase amount “23,000” included in the management information, the judgment unit 135 judges that the action 25 condition “total purchase amount >=100,000 yen” for “ID=3” is not satisfied.

Next, the judgment unit 135 acquires the date of the previous visit “Jan. 1, 2021” included in the management information. In addition, the judgment unit 135 acquires the current date “Mar. 22, 2021” from a clock (not shown). Next, using the pieces of information of the date of the previous visit “Jan. 1, 2021” and the current date “Mar. 22, 2021”, the judgment unit 135 judges that the action condition “period from date of previous visit >=1 month” for “ID=4” is satisfied. Thereafter, the action unit 136 acquires the processing identifier “start_chat” for “ID=4”. Thereafter, the action unit 136 executes “start_chat”. As a result, the terminal device 1 of the user A and the management terminal 3 of the administrator are in a situation where they can start chatting. Thus, the administrator of the EC site to provide appropriate customer service to users who have been away from the EC site for a long time.

Next, the judgment unit 135 judges that the action conditions for “ID=5” and “ID=6” are not met.

Next, the management information acquisition unit 133 adds 1 to the acquired number of visits “9” to acquire the number of visits “10”. Next, the management information accumulation unit 134 updates the number of visits in the management information included in the table in FIG. 10 to “10”.

In addition, the management information accumulation unit 134 updates the date of the pervious visit in the management information included in the table in FIG. 10 to the current date “Mar. 22, 2021”.

In addition, the management information acquisition unit 133 judges that it is necessary to acquire the dynamic attribute value “stay time” from the table in FIG. 10, and keeps incrementing the stay time on the web site, using a clock (timer) (not shown).

Next, it is assumed that the user performs an operation to purchase one product a worth 100,000 yen on the EC site while interacting with the administrator via chat.

As a result, the reception unit 12 receives an operation performed to purchase the product from the user. Next, the processing unit 13 forms operation information (for example, “purchase (product a, 1.100,000 yen)” based on the accepted operation. Next, the transmission unit 14 transmits the formed operation information to the server device 2.

Next, the server device 2 receives the operation information (for example, “purchase (product a, 1, 100,000 yen)”, and performs processing to purchase the product a for the user A. Note that such processing performed by the server device 2 is based on well-known technique, and therefore the detailed description thereof will be omitted.

Next, using the stored rule “increase the score by 1 for every purchase of 10,000 yen” and the price of the current purchase “100,000 yen”, the management information acquisition unit 133 acquires “10” by which the score is to be increased. Next, the management information acquisition unit 133 acquires “52” by adding “10” to the score “42” in the table in FIG. 10. Next, the management information accumulation unit 134 updates the score in the table in FIG. 10 to “52”.

In addition, the management information acquisition unit 133 acquires the total purchase amount “23,000” in the table in FIG. 10. Next, the management information acquisition unit 133 acquires the price of the currently purchased amount “100,000 yen”. Thereafter, the management information acquisition unit 133 acquires “123,000” by adding the total purchase amount “23,000” and “100,000 yen”. Next, the management information accumulation unit 134 updates the total purchase amount in the table in FIG. 10 to “123,000”.

As described above, the management information of the user is updated in response to the users operation on the web page, and an appropriate service (execution of the processing identified by the processing identifier) is provided to the user.

Although the management information of the user is updated, the terminal device 1 here does not transmit the updated management information.

### Specific Example 2

It is assumed that the user A wishes to purchase products at a discount rate higher than usual on the EC site identified by the page identifier “https://www.x.jp”, and fraudulently updates the score of the user from “52” to “90”.

It is assumed that the processing unit 13 of the terminal device 1 of the user A judges that it is the time to transmit management information.

Next, it is assumed that the processing unit 13 acquires management information “<member>1<score>90<number of visits>9<total purchase amount>123,000<date of previous visit>2021/3/22” paired with the page identifier “https://www.x.jp”, from the management information management table. It is assumed here that the processing unit 13 acquires only attribute values (here, history information-using dynamic attribute values) that meet a condition, of the pieces of management information in the management information management table. It is also assumed that “number of visits” is 9.

Thereafter, the processing unit 13 acquires the user identifier “1” stored in the storage unit 11. Next, the management information transmission unit 141 transmits the acquired management information and the user identifier “1” to the server device 2 in pairs. It is assumed that the user A is using the browser X to access the EC site.

Next, the server management reception unit 222 of the server device 2 receives management information “<member>1<score>90<number of visits>9<total purchase amount>123,000<date of previous visit>2021/3/22” and the user identifier “1” from the terminal device 1.

Next, using the received “total purchase amount “123,000”, the stored total purchase amount “23,000”, and the stored score “42”, the server inspection unit 235 judges that “<score>90” is fraudulent, based on the score addition rule “increase the score by 1 for every purchase of 10,000 yen”. Thereafter, the server inspection unit 235 acquires the inspection result (abnormal “0”). In addition, using the fraudulent management information “<score>90”, the server inspection unit 235 forms a message (for example, “Your score ‘90’ may have been tampered with”).

Next, the server transmission unit 24 transmits the acquired inspection result (abnormal “0”) and the message to the terminal device 1.

Next, the terminal device 1 receives and outputs the inspection result and the message. Note that, when the inspection result is “abnormal”, the terminal device 1 may perform processing corresponding to the result. Such processing is, for example, processing that is performed to delete abnormal management information, or processing that is performed to update a value to an initial value. Such processing may also be a processing that is performed to add a flag so that predetermined processing will not be performed, for example.

Next, the server processing unit 23 judges whether or not the received management information (excluding the fraudulent management information) satisfies the server transmission conditions in FIG. 13. Here, the server processing unit 23 judges that “<number of visits>9” in the received management information satisfies the server transmission condition “mod(number of visits/10)=9” for “ID=2”. Note that the server processing unit 23 judges that the server transmission conditions for “ID=1,3,4,5,6”.

Next, the server processing unit 23 acquires the action condition, the processing identifier, and the deletion flag for “ID=2” from the dynamic processing information management table (FIG. 13). Thereafter, the server transmission unit 24 transmits the action condition and the processing identifier to the terminal device 1.

Next, the condition reception unit 151 of the terminal device 1 receives the action condition “number of visits+1”, “the processing identifier “output (coupon information)”, and the deletion flag “1”. Next, the condition accumulation unit 132 accumulates the action condition, the processing identifier, and the deletion flag. Such an accumulated record is the record with “ID=2” in FIG. 11(a).

According to the above specific example 2, fraud such as tampering with 25 management information can be checked. In addition, the action conditions and so on can be transmitted from the server device 2 to the terminal device 1 based on the received management information.

As described above, according to the present embodiment, it is possible to accumulate and use management information that is based on user operations performed on web pages, in association with the web pages.

According to the present embodiment, the terminal device 1 can perform an action corresponding to management information. The action is, for example, an action to switch to a web page corresponding to the management information, or an action for communication such as chatting. Since various kinds of processing is performed using management information on the terminal device 1, the amount of communication data transmitted from the terminal device 1 to the server device 2 is reduced. Therefore, it may also be possible to achieve, for example, the effect of not reducing the processing speed on the terminal device 1, the effect of reducing the load on the server device 2, the effect of reducing the privacy violation caused by sending the users personal information to server device 2, and so on.

In addition, according to the present embodiment, the terminal device 1 can receive an action condition used to judge whether or not to perform an action, from an external device.

In addition, according to the present embodiment, an action condition can be received from a web server in response to access to a web page.

In addition, according to the present embodiment, an action can be performed based on an accepted operation without using already accumulated management information, using an action condition that is based on a change in a dynamic attribute value.

In addition, according to the present embodiment, only necessary management information can be accumulated in the terminal device 1 by accumulating only management information that meets a predetermined accumulation condition.

In addition, according to the present embodiment, only management information that is used for a judgment using an action condition can be accumulated in the terminal device 1.

In addition, according to the present embodiment, the terminal device 1 can transmit management information to the server device. In addition, according to the present embodiment, the terminal device 1 can transmit management information to the server device only when necessary.

In addition, according to the present embodiment, management information can be managed in the terminal device 1 in association with a page identifier or a browser.

In addition, according to the present embodiment, it is possible to provide a server device 2 that can transmit an action condition and the like to the terminal device 1. In addition, according to the present embodiment, it is possible to provide a server device 2 that can transmit an action condition to the terminal device 1 when appropriate.

Furthermore, according to the present embodiment, the server device 2 can check whether or not management information in the terminal device 1 is valid.

Note that, in the present embodiment, the information system may include one or more terminal devices 1, one or more second server devices 4, a server device 5, and one or more management terminals 3. It is assumed that the information system in such a case is an information system B. Note that, in the information system according to the present embodiment, the terminal device 1 need only be able to hold and use management information, and there is no limitation on the functions to be performed by the server device. That is to say, the functions performed by the server device 2 of the information system A may be shared among two or more devices.

Each second server device 4 is a web server that communicates with the terminal devices 1. Each second server device 4 is, for example, a well-known EC site server.

The server device 5 is a server that provides the terminal device 1 with information regarding pairs of action conditions and processing identifiers. The server device 5 may receive management information from the terminal device 1, or receive operation information that is the source of the management information from the second server device 4, and form management information.

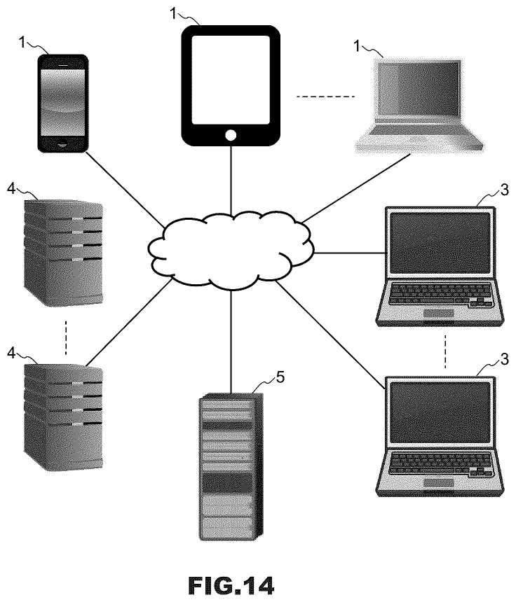

A conceptual diagram for the information system B in such a case is shown in FIG. 14. The information system B includes one or more terminal devices 1, one or more second server devices 4, a server device 5, and one or more management terminals 3. Each second server device 4 and the server device 5 are, for example, an ASP server, a cloud server, or the like. However, there is no limitation on the type of the second server devices 4 and the server device 5.

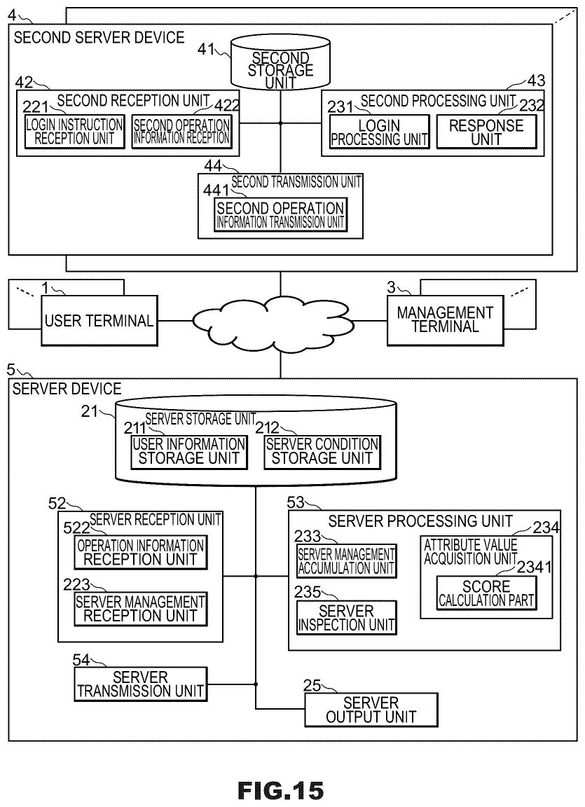

A block diagram for the information system B in such a case is shown in FIG. 15. Each second server device 4 includes a second storage unit 41, a second reception unit 42, a second processing unit 43, and a second transmission unit 44. The second storage unit 41 stores one or more static attribute values for each user. The second reception unit 42 includes a login instruction reception unit 221 and a second operation information reception unit 422. The second operation information reception unit 422 receives operation information from the terminal devices 1. The second processing unit 43 includes a login processing unit 231 and a response unit 232. The second transmission unit 44 includes a second operation information transmission unit 441. The second operation information transmission unit 441 transmits operation information to the server device 5 as necessary. Note that the second transmission unit 44 does not necessarily have to transmit operation information to the server device 5. In such a case, the second operation information transmission unit 441 is unnecessary.

It is preferable that the second storage unit 41 is realized using a non-volatile recording medium, but it can be realized using a volatile recording medium. There is no limitation on the process in which information is stored in the second storage unit 41. For example, information may be stored in the second storage unit 41 via a recording medium, or information transmitted via a communication line or the like may be stored in the second storage unit 41, or information input via an input device may be stored in the second storage unit 41.

The second reception unit 42 and the server reception unit 52 are typically realized using a wireless or wired communication means.

The second processing unit 43 and the server processing unit 53 can typically be realized using a processor, a memory, or the like. The processing procedures performed by the second reception unit 42 and so on are typically realized using software, and the software is recorded on a recording medium such as a ROM. However, the second reception unit 42 may be realized using hardware (a dedicated circuit). Note that the processor may be a CPU, an MPU, a GPU, or the like, and there is no limitation.

The second transmission unit 44 and the server transmission unit 54 are typically realized using a wireless or wired communication means.

The processing in the present embodiment may be realized using software. This software may be distributed through software downloading or the like. Also, this software may be recorded on a recording medium such as a CD-ROM and distributed. Note that the same applies to the other embodiments in the present description. Note that the software that realizes each terminal device 1 according to the present embodiment is the program described below. That is to say, this program is a program that enables a computer to function as: an operation acceptance unit that accepts one or more operations performed on a web page; a management information acquisition unit that acquires management information that is a set of pieces of operation information regarding the one or more operations, or a dynamic attribute value that is based on the set of pieces of operation information; and a management information accumulation unit that accumulates the management information in association with a page identifier that identifies the web page.

The software that realizes each sever device 2 according to the present embodiment is the program described below. That is to say, this program is a program that enables a computer that can access a server storage unit that stores an action condition that is based on a set of pieces of operation information or dynamic attribute values to function as: a server transmission unit that transmits the action condition to a terminal device.

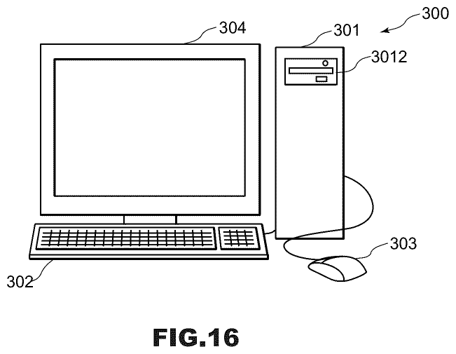

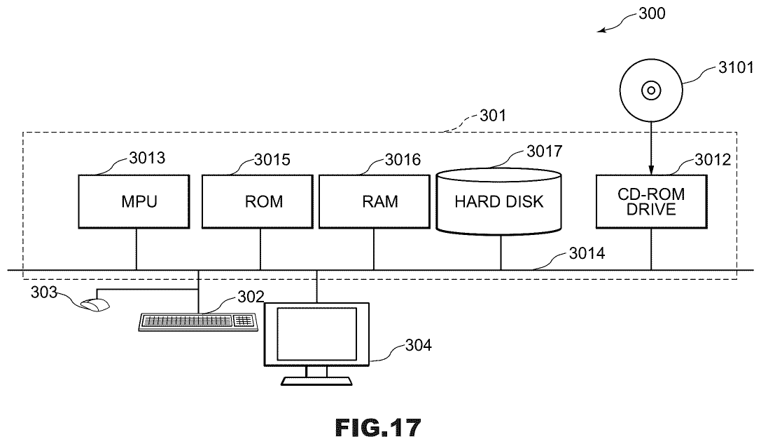

FIG. 16 shows the external appearance of a computer that executes the program described herein to realize the terminal devices 1, the server devices 2, and so on according to the various embodiments described above. The above-described embodiments can be realized using computer hardware and a computer program that runs thereon. FIG. 16 is an overview diagram for this computer system 300 and FIG. 17 is a block diagram for the system 300.

In FIG. 16, the computer system 300 includes a computer 301 that includes a CD-ROM drive 3012, a keyboard 302, a mouse 303, and a monitor 304.

In FIG. 17, the computer 301 includes the CD-ROM drive 3012, an MPU 3013, a bus 3014, a ROM 3015, a RAM 3016, and a hard disk 3017. The ROM 3015 stores programs such as a boot-up program. The RAM 3016 is connected to the MPU 3013 and is used to temporarily store application program instructions and provide a temporary storage space. The hard disk 3017 typically stores application programs, system programs, and data. Here, although not shown in the drawings, the computer 301 may further include a network card that provides connection to a LAN.

The program that enables the computer system 300 to perform the functions of the terminal devices 1 and so on according to the above-described embodiments may be stored in the CD-ROM 3101, inserted into the CD-ROM drive 3012, and furthermore transferred to the hard disk 3017. Alternatively, the program may be transmitted to the computer 301 via a network (not shown) and stored on the hard disk 3017. The program is loaded into the RAM 3016 when the program is to be executed. The program may be directly loaded from the CD-ROM 3101 or the network.

The program does not necessarily have to include an operating system (OS), a third party program, or the like that enables the computer 301 to perform the functions of the terminal devices 1 and so on according to the embodiments described above. The program need only contain the part of the instruction that calls an appropriate module in a controlled manner to achieve a desired result. How the computer system 300 works is well known and the detailed descriptions thereof will be omitted.

In the above-described program, the step of transmitting information, the step of receiving information and so on do not include processing performed by hardware, for example, processing performed by a modem or an interface card in the step of transmitting (processing that can only be performed by hardware).

There may be a single or multiple computers executing the above-described program. That is to say, centralized processing or distributed processing may be performed.

Also, as a matter of course, in each of the above-described embodiments, two or more communication means that are present in one device may be physically realized using one medium.

In each of the above-described embodiments, each kind of processing may be realized as centralized processing that is performed by a single device, or distributed processing that is performed by multiple devices.

As a matter of course, the present invention is not limited to the above-described embodiments, and various changes are possible, and such variations are also included within the scope of the present invention.

### INDUSTRIAL APPLICABILITY

As described above, the terminal device according to the present invention has the effect that management information that is based on user operations performed on a web page can be accumulated in the terminal device and used, and is useful as a terminal or the like for operating web pages.

1. A terminal device comprising:
an operation acceptance unit that accepts one or more operations performed on a web page;
a management information acquisition unit that acquires management information that is a set of pieces of operation information regarding the one or more operations, or a dynamic attribute value that is based on the set of pieces of operation information; and
a management information accumulation unit that accumulates the management information in association with a page identifier that identifies the web page.

2. The terminal device according to claim 1, further comprising:
a judgment unit that judges whether or not the management information acquired by the management information acquisition unit meets an action condition that is based on the set of pieces of operation information or the dynamic attribute value; and
an action unit that, when the judgment unit judges that the management information meets the action condition, performs an action corresponding to the action condition.

3. The terminal device according to claim 2,
wherein the action unit performs screen change processing to change the web page that is being output, or to output another screen on the web page.

4. The terminal device according to claim 2,
wherein the action unit performs chat processing to start a chat with another terminal device.

5. The terminal device according to any one of claims 2 to 4, further comprising:
a condition reception unit that receives the action condition; and
a condition accumulation unit that accumulates the action condition.

6. The terminal device according to claim 5, further comprising:
a page access unit that accesses a web server to acquire a web page; and
a page output unit that outputs the web page in response to the access,
wherein the condition reception unit receives the action condition from the web server in response to the access.

7. The terminal device according to any one of claims 2 to 6,
wherein the action condition is a condition that is based on a change in the dynamic attribute value.

8. The terminal device according to any one of claims 1 to 7,
wherein the management information accumulation unit accumulates only management information that meets a predetermined accumulation condition.

9. The terminal device according to claim 8,
wherein the accumulation condition is that the management information is used in the action condition.

10. The terminal device according to any one of claims 1 to 9, further comprising:
a management information transmission unit that transmits the management information to a server device.

11. The terminal device according to claim 10,
wherein the management information transmission unit transmits the management information to the server device only when a predetermined transmission condition is satisfied.

12. The terminal device according to any one of claims 1 to 11,
wherein the management information accumulation unit accumulates the management information in association with a browser that outputs the web page.

13. An information processing method that is realized using an operation reception unit, a management information acquisition unit, and a management information accumulation unit, the information processing method comprising:
an operation acceptance step in which the operation acceptance unit that accepts one or more operations performed on a web page;
a management information acquisition step in which the management information acquisition unit acquires management information that is a set of pieces of operation information regarding the one or more operations, or a dynamic attribute value that is based on the set of pieces of operation information; and
a management information accumulation step in which the management information accumulation unit accumulates the management information in association with a page identifier that identifies the web page.

14. A recording medium having recorded thereon a program that enables a computer to function as:
an operation acceptance unit that accepts one or more operations performed on a web page;
a management information acquisition unit that acquires management information that is a set of pieces of operation information regarding the one or more operations, or a dynamic attribute value that is based on the set of pieces of operation information; and
a management information accumulation unit that accumulates the management information in association with a page identifier that identifies the web page.
